(19) United States
(12) Patent Application Publication
(10) Pub. No.: US 2025/0353303 A1
(43) Pub. Date: Nov. 20, 2025

(54) INK STORAGE POUCH

(71) Applicant: CANON KABUSHIKI KAISHA, Tokyo (JP)

(72) Inventor: KAZUHISA OKANO, Tokyo (JP)

(21) Appl. No.: 19/205,906

(22) Filed: May 12, 2025

(30) Foreign Application Priority Data
May 15, 2024 (JP) 2024-079561

(51) Int. Cl. B41J 2/175

(52) U.S. Cl. CPC B41J 2/175

(57) ABSTRACT

An ink storage pouch for refilling a liquid discharge apparatus with ink, including: a pouch portion for storing ink; and a nozzle which is provided in the pouch portion and which is equipped with a discharge path that discharges ink from inside of the pouch portion, wherein the nozzle includes a first part in which the discharge path extends in a first direction and a second part in which the discharge path extends in a second direction that intersects with the first direction. The technologies described in this specification have the potential to contribute to the achievement of a sustainable society, such as a decarbonized society/circular society.

### BACKGROUND

### Field of the Technology

The present disclosure relates to an ink storage pouch.

### Description of the Related Art

Recording apparatuses (for example, ink-jet printers) as ink discharge apparatuses (liquid discharge apparatuses) that record on a recording medium by ejecting a liquid such as ink onto the recording medium are conventionally known. With ink discharge apparatuses of this type, when ink in a tank runs low, the tank is refilled with ink by injecting refill ink from a container containing the refill ink into a refill port. As a container for storing the refill ink, a bottle-shaped container or a storage pouch in which a storage bag (pouch) formed by joining a periphery of a flexible film is provided with a spout for pouring out ink may be used. In particular, for example, ink storage pouches may be formed by heat-welding four sides of two films to each other to form a pouch shape (for example, Japanese Patent Application Laid-open No. 2018-2262).

### SUMMARY

In recent years, there is a social need to develop techniques that can contribute towards realizing a sustainable society such as a decarbonized society/circular society. In particular, from a perspective of friendliness to the environment, ink storage pouches are preferable as containers for storing refill ink because they use less material than ink bottles. However, since ink pouches are flexible unlike ink bottles, it may be difficult to align a nozzle with an ink refill receptacle. Accordingly, there are concerns that alignment would take time or that misalignment would result in liquid leakage.

An object of the present disclosure is to provide a technique capable of improving workability in liquid refill work in an ink storage pouch.

In order to achieve the object described above, an ink storage pouch according to the present disclosure for refilling a liquid discharge apparatus includes:
a pouch portion for storing ink; and
a nozzle which is provided in the pouch portion and which is equipped with a discharge path that discharges ink from inside of the pouch portion, wherein the nozzle includes a first part in which the discharge path extends in a first direction and a second part in which the discharge path extends in a second direction that intersects with the first direction.

According to the present disclosure, workability in liquid refill work in an ink storage pouch can be improved.

Further features of the present disclosure will become apparent from the following description of exemplary embodiments with reference to the attached drawings.

### BRIEF DESCRIPTION OF THE DRAWINGS

FIG. 1 is an explanatory diagram of an ink storage pouch according to a first embodiment of the present disclosure;

FIGS. 2A and 2B are explanatory diagrams of an ink storage pouch according to the first embodiment of the present disclosure;

FIGS. 3A and 3B are explanatory diagrams of an ink storage pouch according to a second embodiment of the present disclosure;

FIG. 4 is an explanatory diagram of an ink storage pouch according to a modification of the second embodiment of the present disclosure;

FIGS. 5A and 5B are explanatory diagrams of an ink storage pouch according to a third embodiment of the present disclosure;

FIGS. 6A to 6F are explanatory diagrams of an ink storage pouch according to the third embodiment of the present disclosure;

FIGS. 7A to 7D are explanatory diagrams of an ink storage pouch according to a fourth embodiment of the present disclosure;

FIGS. 8A to 8F are explanatory diagrams of an ink storage pouch according to the fourth embodiment of the present disclosure; and

FIGS. 9A to 9E are explanatory diagrams of an ink storage pouch according to a fifth embodiment of the present disclosure.

### DESCRIPTION OF THE EMBODIMENTS

Modes for implementing the present disclose will now be exemplarily described in detail based on examples with reference to the drawings. However, it is to be understood that dimensions, materials, shapes, relative arrangements, and the like of components described in the embodiments are intended to be changed as deemed appropriate in accordance with configurations and various conditions of apparatuses to which the present disclosure is to be applied. In other words, the scope of the present disclose is not intended to be limited to the embodiments described below. While a plurality of features is described in the respective embodiments presented below, all of the plurality of features are not necessarily essential to the disclosure and the plurality of features may be combined with each other in any way. Moreover, in the accompanying drawings, a same reference numeral will be assigned to a same or similar component among the respective embodiments and overlapping descriptions will be omitted.

### First Embodiment

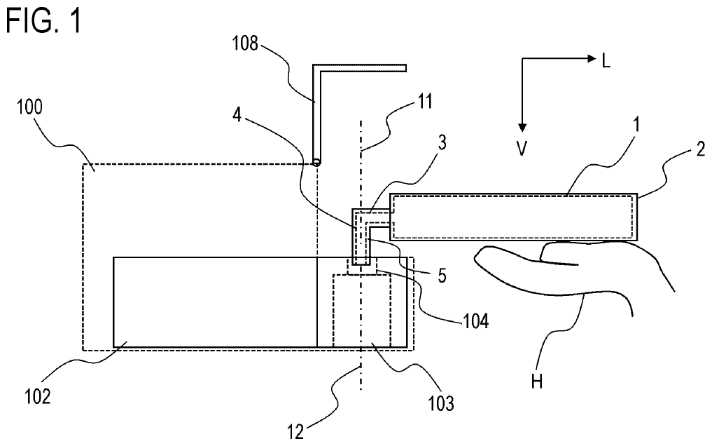

FIG. 1 shows a diagram describing an example of supplying ink directly from an ink storage pouch 1 (liquid storage pouch) according to a first embodiment of the present disclosure to an ink supply receptacle 104 of a sub-ink tank 103 included in an ink-jet printer 100.

The ink-jet printer 100 is a liquid discharge apparatus constituted of a recording mechanism 102 and the sub-ink tank 103. The recording mechanism 102 includes an ink-jet head (recording head) (not illustrated) which discharges ink supplied from the sub-ink tank 103 to a recording medium and performs recording. Characters, symbols, images, and the like are formed by selectively causing liquids of a plurality of colors to be discharged from the ink-jet head and depositing the liquids on the recording medium. Any recording medium may be used as long as the recording medium is capable of forming images and the like by depositing liquid droplets. For example, mediums of various materials and forms can be used as the recording medium including paper, cloth, optical disc label surfaces, plastic sheets, OHP sheets, and envelopes. While the liquid stored in a liquid storage container to which the present disclosure can be applied is typically ink, the liquid is not limited to ink and may also be a reaction fluid or a pretreatment fluid that the liquid discharge apparatus is refilled with.

The ink-jet printer 100 includes an open/close cover 108, and when the open/close cover 108 is opened, the ink supply receptacle 104 of the sub-ink tank 103 is exposed. The sub-ink tank 103 is provided for each type of ink (for example, each color of ink) used for recording. When ink is consumed by recording and the amount of ink stored in the sub-ink tank 103 becomes low, the sub-ink tank 103 can be refilled with the ink from the ink storage pouch 1.

As shown in FIG. 1, when the sub-ink tank 103 of the ink-jet printer 100 is directly refilled with ink from the ink storage pouch 1, the refill of the ink is performed by connecting a nozzle 4 to the ink supply receptacle 104. At this point, due to formation of a folded structure in the nozzle 4, an ink storage bag 2 which is flexible and difficult to hold with the palm of a hand H can be positioned and held in a stable horizontal direction in an ink storage pouch 1. The ink storage pouch 1 according to the present embodiment has a folded structure in which the nozzle 4 is constituted of a piping portion 3 (first part) that is shaped so as to protrude from the ink storage bag 2 and a tip piping portion 5 (second part) that is bent from a tip of the piping portion 3. Connection of the ink storage pouch 1 and the sub-ink tank 103 is performed by inserting the tip piping portion 5 that extends vertically downward into the ink supply receptacle 104 that opens vertically upward. Due to the nozzle 4 having the folded structure described above, the nozzle 4 and the ink supply receptacle 104 can be readily positioned in a stable holding posture in which the ink storage bag 2, which is flexible and readily becomes unstable when held by the hand H, is placed on the palm of the hand H. Note that the ink-jet printer 100 shown in FIG. 1 is installed on a horizontal surface as a normally assumed installation condition (normal use condition).

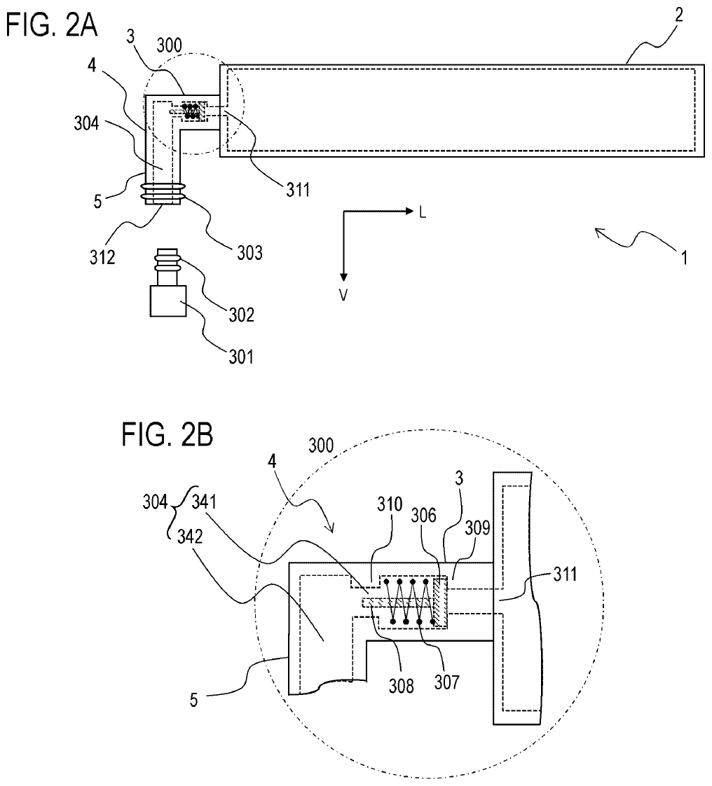

Details of the ink storage pouch 1 will be described with reference to FIGS. 2A and 2B. FIGS. 2A and 2B are explanatory configuration diagrams of the ink storage pouch 1 according to the present embodiment, in which FIG. 2A shows a sectional configuration of the ink storage pouch 1 and a configuration of a lid portion 301 and FIG. 2B is an enlarged view of a mechanism 300 indicated by a dashed-dotted circle in FIG. 2A.

As shown in FIGS. 2A and 2B, the ink storage pouch 1 includes the flexible ink storage bag 2 as a pouch portion for storing ink and the nozzle 4 that forms a discharge path for discharging ink from the inside of the ink storage bag 2 to the outside. An outer peripheral portion of the ink storage bag 2 is formed in a flattened shape and sealed by heat fusion or the like to create a structure that prevents leakage of liquid. The ink storage bag 2 is integrally provided with the nozzle 4 at one end in a longitudinal direction L (a part corresponding to one of the short sides of an approximate rectangle in a plan view) thereof. The nozzle 4 is provided so as to protrude from one end in the longitudinal direction L of the ink storage bag 2 approximately along the longitudinal direction L.

The ink storage bag 2 is a part which is flexible and which is deformable due to pressure applied from stored ink in the ink storage pouch 1. On the other hand, in the ink storage pouch 1, the nozzle 4 is a part which has rigidity that enables the nozzle 4 to keep a constant shape with respect to pressure that is applied by the stored liquid. In other words, it can be said that the ink storage pouch 1 is largely constituted of flexible parts. The ink storage pouch 1 according to the present embodiment can, for example, discharge ink inside the flexible ink storage bag 2 to the outside of the ink storage pouch 1 (ink storage bag 2) through the nozzle 4 by applying a pressing force to the ink storage bag 2.

The ink storage bag 2 is formed of a material with flexibility, a gas barrier property, and liquid impermeability as a first material. For example, the ink storage bag 2 may be constituted of a film-like member such as polyethylene terephthalate (PET), nylon, or polyethylene. In addition, the ink storage bag 2 may be constructed by stacking a plurality of sheets of a film-like member constituted of the raw material described above. In this case, for example, an outer layer may be formed by a film of PET or nylon with excellent impact resistance and an inner layer may be formed by a polyethylene film with excellent ink resistance. Furthermore, a layer of aluminum or other vapor-deposited material may be added to the stacked structure.

A material (second material) constituting the nozzle 4 is plastic and, more specifically, a resin such as polypropylene. A through-flow path 304 (discharge path) for supplying a liquid (discharging a liquid from inside the ink storage bag 2) is formed in the nozzle 4. The through-flow path 304 includes an introducing port 311 (port) that opens inside the ink storage bag 2 to introduce ink inside the ink storage bag 2 into the through-flow path 304 and a discharge port 312 for discharging ink flowing through the through-flow path 304 to the outside of the ink storage pouch 1 (ink storage bag 2).

The nozzle 4 of the ink storage pouch 1 according to the present embodiment has the folded structure described below. Specifically, the nozzle 4 includes the piping portion 3 as a first part and the tip piping portion 5 as the second part which extend in directions that intersect with each other. The piping portion 3 is a part that is connected to the ink storage bag 2 and extends in a longitudinal direction L of the ink storage bag 2. The tip piping portion 5 is a part that bends and extends from a tip of the piping portion 3 extending from the ink storage bag 2 and extends in a direction intersecting with the longitudinal direction L of the ink storage bag 2 which is a direction V orthogonal to the longitudinal direction L of the ink storage bag 2 in the present embodiment. In other words, in the present embodiment, the piping portion 3 and the tip piping portion 5 are arranged so as to form an approximate L shape. The through-flow path 304 is formed in a direction in which the piping portion 3 and the tip piping portion 5 extend.

When the ink storage pouch 1 is held so that the longitudinal direction L of the ink storage bag 2 is parallel to the horizontal direction, in the present embodiment, the direction in which the piping portion 3 extends (first direction) is the horizontal direction and the direction V in which the tip piping portion 5 extends (second direction) is the vertical direction. The through-flow path 304 includes a first flow path 341 (first discharge path) provided in the piping portion 3 and a second flow path 342 (second discharge path) provided in the tip piping portion 5. The first flow path 341 extends in the direction in which the piping portion 3 extends (first direction) and the second flow path 342 extends in the direction in which the tip piping portion 5 extends (second direction). The introducing port 311 is provided in the first flow path 341 and opens in the longitudinal direction L, and the discharge port 312 is provided in the second flow path 342 and opens in a direction that intersects with the longitudinal direction L which is the direction V orthogonal to the longitudinal direction L in the present embodiment.

In addition, the ink storage pouch 1 according to the present embodiment is equipped with a removable lid portion 301 made of plastic or, more specifically, a resin such as polypropylene, to prevent leakage of ink when not in use. An O-ring 303 for preventing liquid leakage is formed near a tip of the tip piping portion 5 of the nozzle 4 and an O-ring 302 for preventing liquid leakage is formed in the lid portion 301. When the ink storage pouch 1 is not in use, in order to prevent ink leakage, the lid portion 301 is connected to the tip of the tip piping portion 5 of the nozzle 4 to seal the discharge port 312 that opens at the tip of the tip piping portion 5.

A mechanism 300 that stops feeding of ink when the ink storage bag 2 is not subjected to pressure is formed near the base of the nozzle 4 (first part 41). The mechanism 300 that stops feeding of liquid is made of a resin such as polypropylene and is constituted of a valve body 306 that includes a valve shaft 308, a spring 307, a shaft bearing portion 310, and a valve body stopping portion 309. The shaft bearing portion 310 and the valve body stopping portion 309 are formed by reducing a diameter of a part of the first flow path 341 of the through-flow path 304.

The valve body 306 and the valve shaft 308 as sealing members are arranged inside the first flow path 341 of the through-flow path 304 and form a state of stopping feeding of liquid by coming into contact with a wall surface (valve body stopping portion 309) of the first flow path 341 so as to block the introducing port 311 from inside of the through-flow path 304. The valve body 306 is held at a sealing position where the valve body 306 blocks the introducing port 311 due to action of a biasing force of the spring 307 as a biasing member. The biasing force exerted on the valve body 306 by the spring 307 is set greater than a pressurizing force when only the weight of the ink contained inside the ink storage bag 2 acts on the valve body 306.

When the ink storage bag 2 is pressurized, the valve body 306 is pushed out to a nozzle tip side together with ink and the ink is supplied through the through-flow path 304. In other words, when an external force is applied to the ink storage bag 2 and the pressurizing force that acts on the valve body 306 from inside the ink storage bag 2 becomes larger than the biasing force of the spring 307, the valve body 306 moves to a non-sealing position at which the valve body 306 separates from the valve body stopping portion 309. Accordingly, the ink inside the ink storage bag 2 is introduced from the introducing port 311 into the through-flow path 304 and discharged from the discharge port 312 to outside of the ink storage pouch 1. When pressure applied to the ink storage bag 2 is low or non-existent, the valve body 306 is pressed against the valve body stopping portion 309 by the spring 307 and liquid is prevented from flowing, a flow of ink is eliminated and unnecessary ink leakage and the like is prevented.

As shown in FIG. 1, a folding angle of the folded structure of the nozzle 4 is configured to be in the following range when the ink storage bag 2 is held in the horizontal direction (held so that the longitudinal direction L of the ink storage bag 2 is the horizontal direction). In other words, an angle formed by an axis 11 formed by the tip piping portion 5 and an axis 12 formed by the ink supply receptacle 104 of the sub-ink tank 103 preferably ranges from 0° or more to 15° or less, with a parallel state being 0°. For example, the axis 11 is a virtual axis passing through a center of the discharge port 312 and the axis 12 is a virtual axis passing through a center of the ink supply receptacle 104.

### Second Embodiment

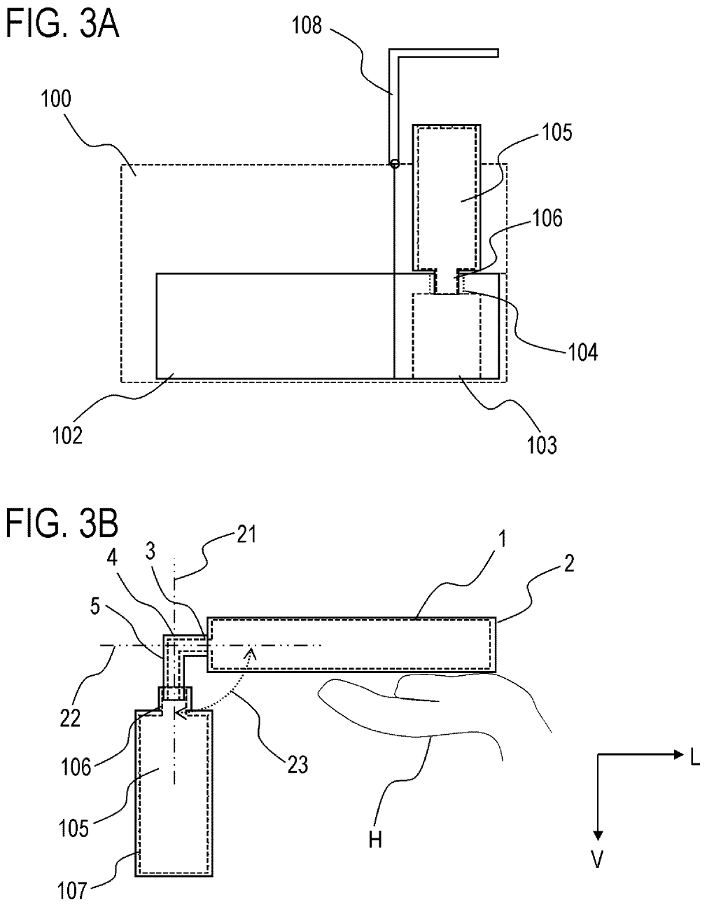

FIGS. 3A and 3B are diagrams illustrating a second embodiment that is a modification of the first embodiment. Here, only components of the second embodiment that differ from components of the first embodiment will be described and descriptions of components in common with those of the first embodiment will not be repeated. A configuration of the second embodiment which will not be specifically described here is similar to that of the first embodiment.

The second embodiment adopts a configuration in which, as a refill destination of ink of the ink storage pouch 1, ink is refilled from the ink storage pouch 1 to the ink-jet printer 100 via an ink refill bottle 105 instead of directly from the ink storage pouch 1 to the ink-jet printer 100.

FIG. 3A is an explanatory diagram showing a situation according to the present embodiment in which ink is refilled from the ink storage pouch 1 to the ink-jet printer 100 via the ink refill bottle 105 instead of directly from the ink storage pouch 1 to the ink-jet printer 100. When ink is consumed by recording and the amount of ink stored in the sub-ink tank 103 becomes low, the sub-ink tank 103 can be refilled with the ink from the ink refill bottle 105. When refilling ink, ink is supplied due to the ink's own weight or a suction mechanism (not illustrated) by connecting a nozzle 106 of the ink refill bottle 105 and the ink supply receptacle 104 of the sub-ink tank 103 to each other.

FIG. 3B is an explanatory diagram showing a situation where ink is refilled from the ink storage pouch 1 as a first liquid refill container to the ink refill bottle 105 as a second liquid refill container. When an amount of ink in the ink refill bottle 105 is low, ink is refilled by the ink storage pouch 1 as shown in FIG. 3B. Specifically, ink is refilled by placing the ink refill bottle 105 on a horizontal surface and inserting the tip piping portion 5 of the nozzle 4 of the ink storage pouch 1 into an opening of the nozzle 106 facing upward in the vertical direction. The ink storage pouch 1 according to the present embodiment is configured in a similar manner to the ink storage pouch 1 according to the first embodiment. Specifically, the nozzle 4 is constructed in an approximate L shape in which the piping portion 3 (first part) and the tip piping portion 5 (second part) are approximately orthogonal to each other. A reference line 21 that extends perpendicular with respect to an opening surface of the nozzle 106 of the ink refill bottle 105 extends in the vertical direction. In contrast, a reference line 22 that extends in the vertical direction with respect to a piping cross section of the piping portion 3 of the nozzle 4 of the ink storage pouch 1 in which the ink storage bag 2 is held such that the longitudinal direction of the ink storage bag 2 is the horizontal direction extends in the horizontal direction. Therefore, an angle 23 formed by the reference line 21 and the reference line 22 is 90°.

When refilling ink from the ink storage pouch 1 to the ink refill bottle 105, first, the tip piping portion 5 of the nozzle 4 is inserted into or connected to the nozzle 106 of the ink refill bottle 105. In addition, after stabilizing a support state of the ink storage pouch 1 by, for example, placing the ink storage bag 2 on the palm of the hand H so that a lateral portion of the ink storage bag 2 faces downward, the ink storage bag 2 is pressurized to push out the ink therein. Accordingly, the ink stored in the ink storage bag 2 can be injected into the nozzle 106 of the ink refill bottle 105 in a stable manner.

Due to the folded structure of the nozzle 4 described above, the ink storage pouch 1 which is flexible and difficult to hold with the palm of the hand H can be positioned and held in a stable horizontal direction. Accordingly, the nozzle 4 of the ink storage pouch 1 and the nozzle 106 of the ink refill bottle 105 can be readily positioned.

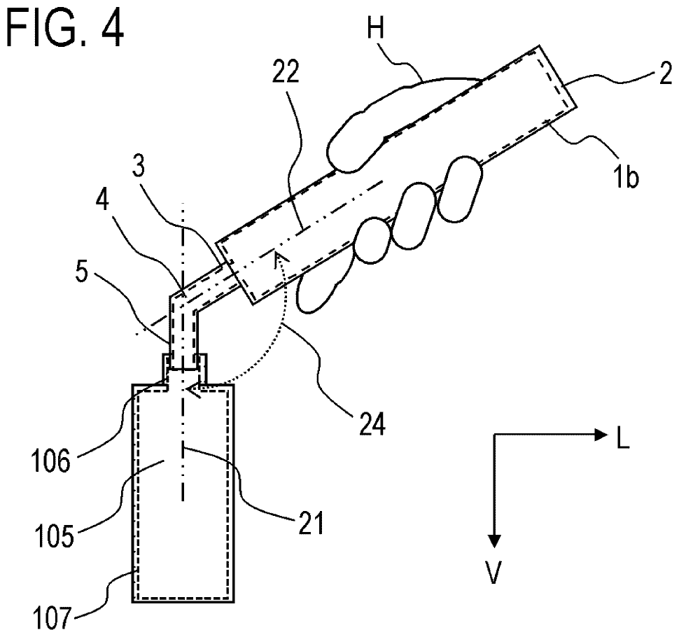

FIG. 4 is an explanatory diagram showing a situation where ink is refilled from an ink storage pouch 1b as a first liquid refill container to the ink refill bottle 105 as a second liquid refill container according to a modification of the second embodiment. The ink storage pouch 1b is constructed so that the angle formed by the piping portion 3 (first direction) and the tip piping portion 5 (second direction) of the nozzle 4 is 120° instead of 90° as in the ink storage pouch 1. Therefore, the reference line 21 that extends perpendicular with respect to the opening surface of the nozzle 106 of the ink refill bottle 105 extends in the vertical direction. In contrast, the reference line 22 that extends in the vertical direction with respect to the piping cross section of the tip piping portion 5 of the nozzle 4 of the ink storage pouch 1b in which the tip piping portion 5 is connected to the nozzle 106 extends in a direction at an angle of 120° with respect to the vertical direction. Therefore, an angle 24 formed by the reference line 21 and the reference line 22 is 120°. Due to the nozzle 4 including the folded portion, the efficiency with which the ink filled in the ink storage pouch 1 is refilled into the ink refill bottle 105 is improved due to the effect of the ink's own weight.

The angles 23 and 24 preferably range from 90° or more to 150° or less in consideration of the stability of the support state and the effect of ink refill under the ink's own weight when holding the ink storage bag 2 with the hand H. In addition, the ink storage bag 2 according to the present embodiment as shown in FIG. 4 can also be used in a suitable manner with respect to a configuration in which ink is directly refilled to the sub-ink tank 103 of the ink-jet printer 100 as shown in FIG. 1.

### Third Embodiment

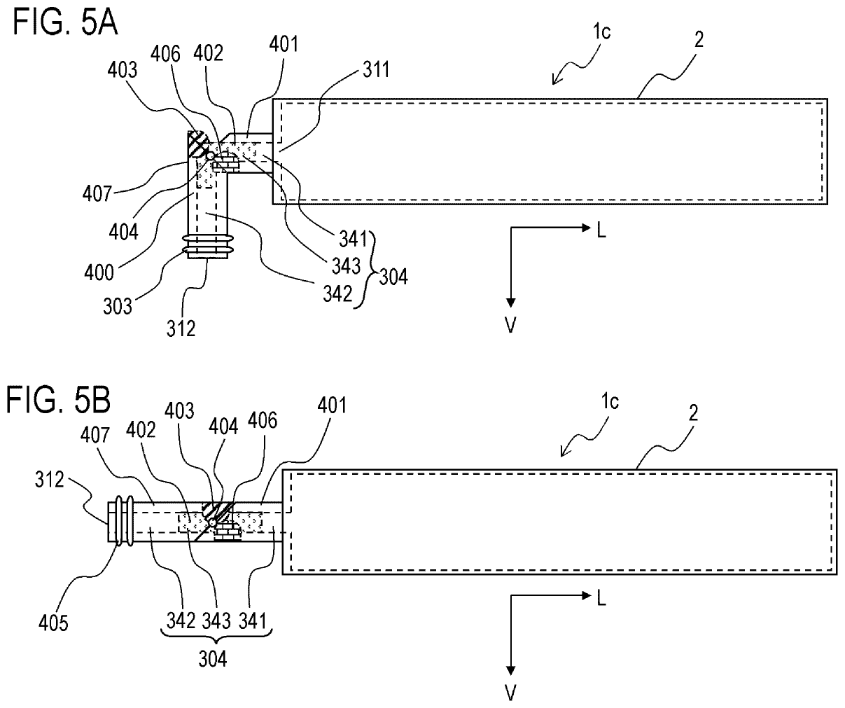

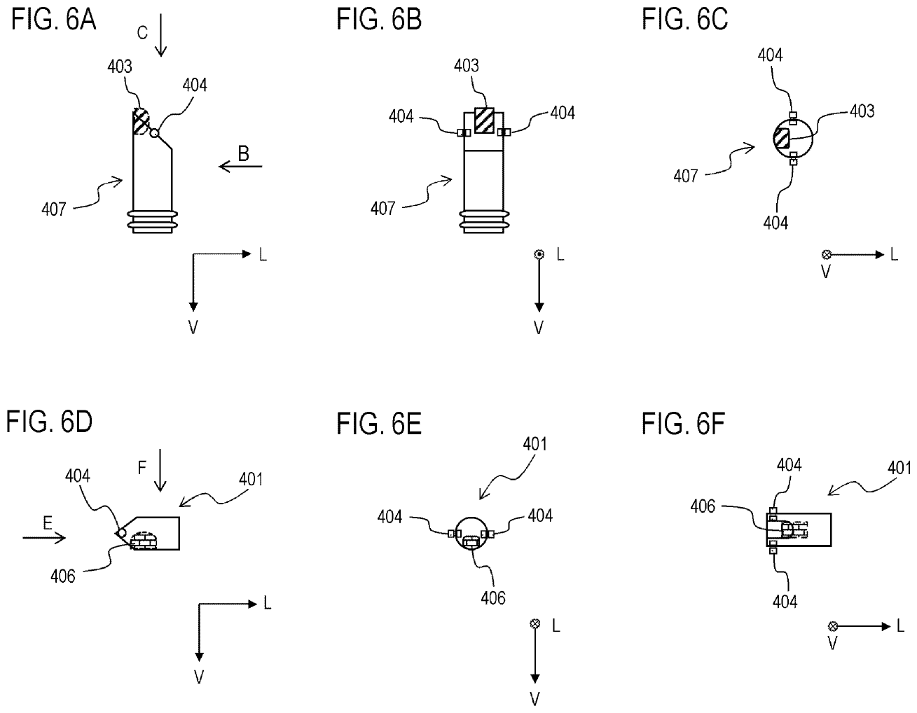

A third embodiment of the present disclosure will be described with reference to FIGS. 5A, 5B, and 6A to 6F. Here, only components of the third embodiment that differ from components of the first and second embodiments will be described and descriptions of components in common with those of the first and second embodiments will not be repeated. A configuration of the third embodiment which will not be specifically described here is similar to that of the first and second embodiments.

The present embodiment is an example of a configuration in which a tip portion as a second part of a nozzle is configured so that a relative posture with respect to the ink storage bag of the tip portion is variable and refill of ink is allowed when a direction in which the tip portion extends assumes a predetermined direction (second direction). Since an ink refill method to the sub-ink tank 103 of the ink-jet printer 100 using an ink storage pouch and an ink refill method to the ink refill bottle 105 are the same as the methods according to the first and second embodiments, detailed descriptions thereof will be omitted.

As shown in FIGS. 5A and 5B, an ink storage pouch 1c according to the present embodiment includes a nozzle 400 having a movable folded structure. The nozzle 400 is configured such that a root portion 401 as a first part integrally provided in the ink storage bag 2 and a tip portion 407 as a second part having the discharge port 312 are coupled to each other by a movable shaft 404 so as to be relatively rotatable. FIG. 5A is a schematic view of the ink storage pouch 1c when the nozzle 400 assumes a folded shape in which the root portion 401 and the tip portion 407 are arranged so that their respective directions of extension intersect with each other (ink suppliable state). FIG. 5B is a schematic view of the ink storage pouch 1c when the nozzle 400 assumes a linear shape in which the root portion 401 and the tip portion 407 are arranged so that their respective directions of extension are the same direction (ink unsuppliable state).

FIG. 6A is a schematic view showing only the tip portion 407 and the movable shaft 404 of the nozzle 400, FIG. 6B is a B-sagittal view of FIG. 6A, and FIG. 6C is a C-sagittal view of FIG. 6A. FIG. 6D is a schematic view showing only the root portion 401 and the movable shaft 404 of the nozzle 400, FIG. 6E is an E-sagittal view of FIG. 6D, and FIG. 6F is an F-sagittal view of FIG. 6A. The movable shaft 404 is, for example, a bolt made of resin such as polypropylene or a bolt made of metal such as aluminum. As shown in FIGS. 6A to 6F, the movable shaft 404 is provided in pairs on both sides across a hollow space so that it does not intersect respective hollow spaces of the root portion 401 and the tip portion 407, and connects the root portion 401 and the tip portion 407.

As shown in FIGS. 5A and 5B, a resin piping 402 that is a flexible tube is coupled as a third part in a region including the movable shaft 404 between the root portion 401 and the tip portion 407. The resin piping 402 is a soft member made of plasticizer-added vinyl chloride or the like. The through-flow path 304 of the nozzle 400 is constituted of the first flow path 341 (first discharge path) in the root portion 401, the second flow path 342 (second discharge path) in the tip portion 407, and a third flow path 343 (third discharge path) constituted of an inner cylindrical portion of the resin piping 402. The third flow path 343 is a flow path that connects the first flow path 341 and the second flow path 342 to each other.

As shown in FIGS. 5A, 5B, and 6A to 6F, a projecting portion 406 (first pressing portion) is formed on an inner side of the root portion 401 and a projecting portion 403 (second pressing portion) is formed on an inner side of the tip portion 407. The projecting portion 406 and the projecting portion 403 are configured so as to be capable of coming into contact with an outer surface of the resin piping 402, respectively, the positions of contact are opposite to each other, and are arranged in an opposing arrangement across the resin piping 402. The projecting portion 406 and the projecting portion 403 are arranged to change their relative positions to each other so that a spacing (gap) between the projecting portion 406 and the projecting portion 403 changes as the relative positions of the root portion 401 and the tip portion 407 change.

As shown in FIG. 5A, when the tip portion 407 is in an L-shaped folded arrangement with respect to the root portion 401, the projecting portion 406 and the projecting portion 403 are arranged spaced apart from each other so that a predetermined gap is created therebetween. At this point, the third flow path 343 of the resin piping 402 is capable of distributing ink and ink can be fed from the inside of the ink storage bag 2 to the outside of the ink storage pouch 1c (ink storage bag 2).

On the other hand, as shown in FIG. 5B, when the tip portion 407 is arranged in a linear shape (not folded) with respect to the root portion 401, the gap between the projecting portion 403 and the projecting portion 406 narrows. Accordingly, the resin piping 402 is sandwiched and crushed between the projecting portion 403 and the projecting portion 406, creating a state where the third flow path 343 is blocked and the feeding of ink is stopped. In other words, when the nozzle 400 is folded into an L-shape, the relative positions of the projecting portion 403 and the projecting portion 406 assume an open position, and the third flow path 343 opens and creates a state where ink can be fed. In addition, when the nozzle 400 assumes a linear shape, the relative positions of the projecting portion 403 and the projecting portion 406 assume a closed position, and the third flow path 343 closes and creates a state where the feeding of ink is stopped.

As described above, by adopting a movable configuration of the nozzle 400 so that the nozzle 400 can be switched between a folded shape and a linear shape and a configuration in which an ink feeding piping can be opened or closed depending on shape changes, the need for a lid such as that according to the first embodiment can be eliminated.

### Fourth Embodiment

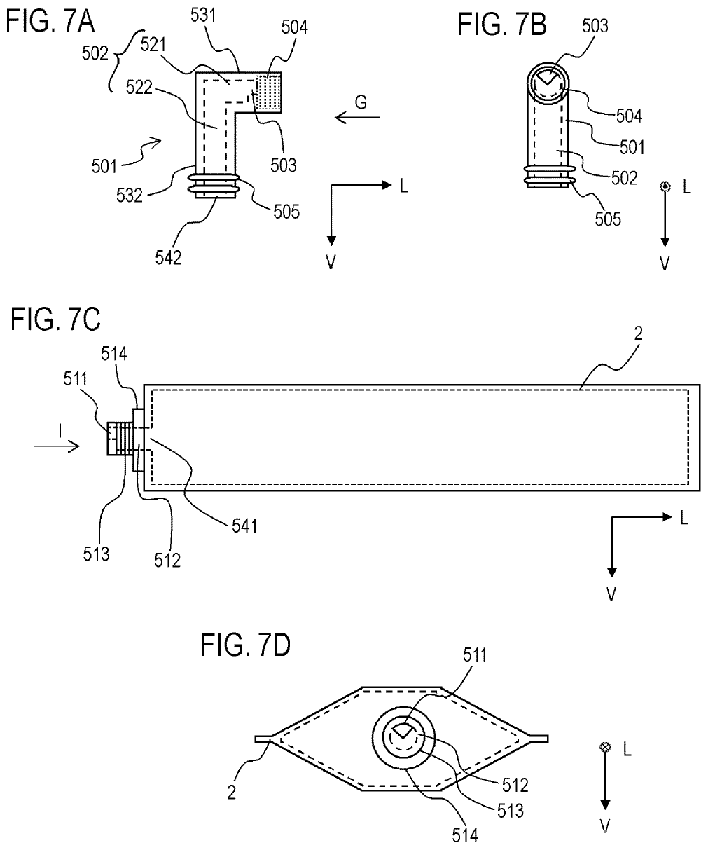

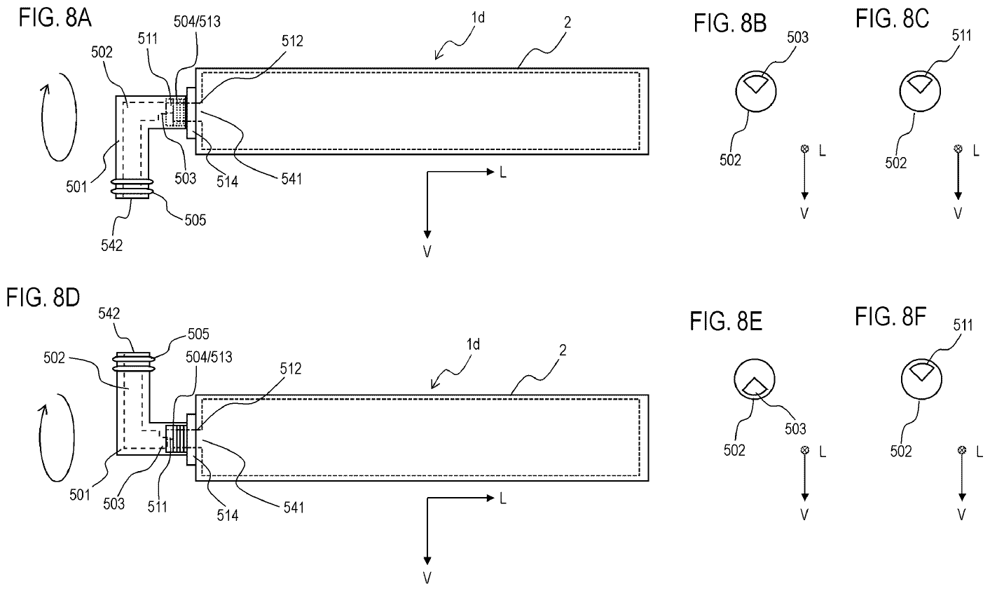

A fourth embodiment of the present disclosure will be described with reference to FIGS. 7A to 7D and 8A to 8F. Here, only components of the fourth embodiment that differ from components of the first to third embodiments will be described and descriptions of components in common with those of the first to third embodiments will not be repeated. A configuration of the fourth embodiment which will not be specifically described here is similar to that of the first to third embodiments.

The present embodiment is an example of a configuration in which a tip portion as a second part of a nozzle is configured so that a relative posture with respect to the ink storage bag of the tip portion is variable and refill of ink is allowed when a direction in which the tip portion extends assumes a predetermined direction (second direction). Since an ink refill method to the sub-ink tank 103 of the ink-jet printer 100 using an ink storage pouch and an ink refill method to the ink refill bottle 105 are the same as the methods according to the first and second embodiments, detailed descriptions thereof will be omitted.

FIGS. 7A and 7B are diagrams showing a configuration of a part made up of a longitudinal portion 531 as a first part and a tip portion 532 as a second part of a nozzle 501 having an L-shaped folded shape, in which FIG. 7B is a G-sagittal view of FIG. 7A. The longitudinal portion 531 and the tip portion 532 of the nozzle 501 have an integral configuration arranged in an approximate L-shape. A tip of the tip portion 532 has a discharge port 542 that opens on a tip surface and an O-ring 505 on an outer circumference of the tip portion for improving sealing performance when connected to the ink supply receptacle 104. A first flow path 521 (first discharge path) is provided in the longitudinal portion 531, a second flow path 522 (second discharge path) is provided in the tip portion 532, which together with a third flow path (third discharge path) 512 provided in a root portion 514 to be described later form a through-flow path 502 capable of feeding ink. An inner circumferential connecting portion 504 capable of connecting with the root portion 514 that is integrally provided at one end in the longitudinal direction L (a part corresponding to one of the short sides of an approximate rectangle in a plan view) of the ink storage bag 2 is formed on an upstream side in an ink feeding direction of the first flow path 521 of the longitudinal portion 531. In addition, a fan-shaped through-hole 503 is formed on a downstream side of the inner circumferential connecting portion 504 in the ink feeding direction of the first flow path 521 so as to narrow a flow path area of ink feeding in a localized manner.

FIGS. 7C and 7D are diagrams showing a configuration of the ink storage bag 2 and the root portion 514 as a third part of the nozzle 501, in which FIG. 7D is an I-sagittal view of FIG. 7C. The root portion 514 is integrally provided with the ink storage bag 2 at one longitudinal end of the ink storage bag 2. The root portion 514 includes an introducing port 541 (port) that opens to inside of the ink storage bag 2, the third flow path 512 that extends in the longitudinal direction L from the introducing port 541, and an outer circumferential connecting portion 513 to be fitted with the inner circumferential connecting portion 504 of the longitudinal portion 531. In addition, a fan-shaped through-hole 511 is formed at a downstream end in the ink feeding direction of the third flow path 512 so as to narrow a flow path area of ink feeding in a localized manner.

The inner circumferential connecting portion 504 of the longitudinal portion 531 and the outer circumferential connecting portion 513 of the root portion 514 are configured so as to be concentrically connectible and freely rotatable relative to each other and to connect the longitudinal portion 531 and the root portion 514 so as to be mutually rotatable while maintaining a sealing property of the ink. Connecting the longitudinal portion 531 and the root portion 514 creates a state where a surface on which the through-hole 503 of the longitudinal portion 531 opens and a surface on which the through-hole 511 of the root portion 514 come into contact with each other.

The through-hole 503 and the through-hole 511 are arranged at positions that do not intersect with a rotational axis of relative rotation of the longitudinal portion 531 and the root portion 514. Therefore, the through-hole 503 and the through-hole 511 are configured so that their relative positions to each other can be changed by a relative rotation of the longitudinal portion 531 and the root portion 514. A relative rotation phase of the longitudinal portion 531 and the root portion 514 includes an opened phase (open position) where the through-hole 503 and the through-hole 511 overlap with each other and the first flow path 521 and the third flow path 512 are communicated with each other. In addition, a rotation phase of the longitudinal portion 531 and the root portion 514 includes a closed phase (closed position) where the through-hole 503 and the through-hole 511 do not overlap with each other and the first flow path 521 and the third flow path 512 are not communicated with each other.

FIG. 8A is a diagram that shows a configuration of an ink storage pouch 1d according to the present embodiment and shows a situation where the through-hole 503 and the through-hole 511 are in the opened phase in which the through-hole 503 and the through-hole 511 overlap with each other. FIG. 8B shows an arrangement of the through-hole 503 when viewed in the longitudinal direction L and FIG. 8C shows an arrangement of the through-hole 511 when viewed in the longitudinal direction L. When the through-hole 503 and the through-hole 511 are in the opened phase in which the through-hole 503 and the through-hole 511 overlap with each other, for example, by applying pressure to the ink storage bag 2, the ink inside the ink storage bag 2 can be discharged from the discharge port 542 (the ink can be fed) via the through-flow path 502. Accordingly, the ink can be fed to the ink supply receptacle 104 and the like.

FIG. 8D is a diagram that shows a configuration of the ink storage pouch 1d according to the present embodiment and shows a situation where the through-hole 503 and the through-hole 511 are in the closed phase in which the through-hole 503 and the through-hole 511 do not overlap with each other. FIG. 8E shows an arrangement of the through-hole 503 when viewed in the longitudinal direction L and FIG. 8F shows an arrangement of the through-hole 511 when viewed in the longitudinal direction L. In this state, since the through-flow path 502 is blocked at the locations where the through-hole 503 and the through-hole 511 are provided, ink is not fed downstream in the through-flow path 502 even when pressure is applied to the ink storage bag 2.

As shown in FIG. 8A, a direction of extension of the tip portion 532 of the nozzle 501 when the opened phase is formed is configured to be downward in the vertical direction when the ink storage bag 2 is held in a position where its longitudinal direction L is parallel to the horizontal direction. Accordingly, in a similar manner to the first embodiment, the tip portion 532 of the nozzle 501 can be readily positioned and inserted with respect to the ink supply receptacle 104 of the sub-ink tank 103 that opens upward in the vertical direction.

In addition, as shown in FIG. 8B, a direction of extension of the tip portion 532 of the nozzle 501 when the closed phase is formed is configured to be upward in the vertical direction when the ink storage bag 2 is held in a position where its longitudinal direction L is parallel to the horizontal direction. Accordingly, a configuration is adopted in which ink leakage does not occur in a state where the tip portion 532 extends in a direction where it is difficult to insert the tip portion 532 into the ink supply receptacle 104 that opens upward in the vertical direction.

As described above, according to the present embodiment, opening and closing of ink feeding can be controlled according to an orientation of the folded portion of the nozzle 501. In addition, the folded shape of the nozzle 501 can assist in enabling the nozzle 501 to rotate readily.

### Fifth Embodiment

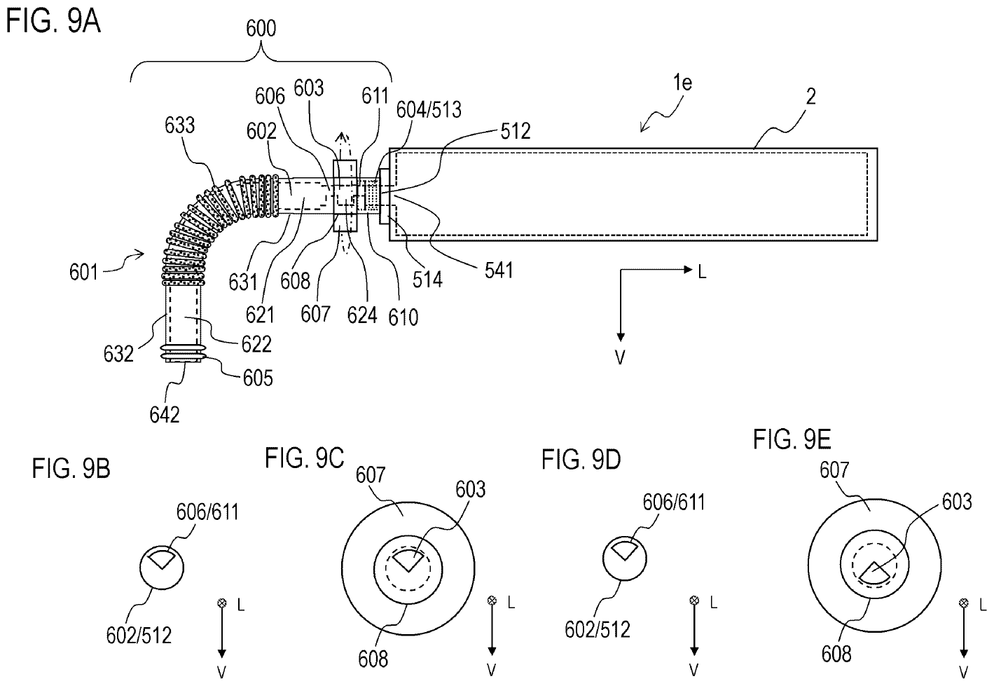

A fifth embodiment of the present disclosure will be described with reference to FIGS. 9A to 9E. Here, only components of the fifth embodiment that differ from components of the first to fourth embodiments will be described and descriptions of components in common with those of the first to fourth embodiments will not be repeated. A configuration of the fifth embodiment which will not be specifically described here is similar to that of the first to fourth embodiments.

Since an ink refill method to the sub-ink tank 103 of the ink-jet printer 100 using an ink storage pouch and an ink refill method to the ink refill bottle 105 are the same as the methods according to the first and second embodiments, detailed descriptions thereof will be omitted.

FIG. 9A shows a configuration of an ink storage pouch 1e according to the present embodiment which is equipped with a nozzle 600 including a folded structure. The ink storage pouch 1e according to the present embodiment is configured so that the nozzle 600 that is unique to the present embodiment is attached to the ink storage bag 2 and the root portion 514 (third part) similar to those shown in FIGS. 7C and 7D according to the fourth embodiment. The nozzle 600 includes a tip nozzle 601 configured so that a longitudinal portion 631 as a first part and a tip portion 632 as a second part are coupled to each other via a bellows portion 633 so as to be capable of arbitrarily changing their relative positions. The inclusion of the bellows portion 633 in the nozzle 600 facilitates positioning of a discharge port 642 of the nozzle 4 with the ink supply receptacle.

A tip of the tip portion 632 has the discharge port 642 that opens on a tip surface and an O-ring 605 on an outer circumference of the tip portion for improving sealing performance when connected to the ink supply receptacle 104. A first flow path 621 (first discharge path) is provided in the longitudinal portion 631 and a second flow path 622 (second discharge path) is provided in the tip portion 632. A fan-shaped through-hole 606 is formed at an upstream end in the ink feeding direction of the first flow path 621 so as to narrow a flow path area of ink feeding in a localized manner.

In addition, the nozzle 600 includes a connecting portion 610 to be connected to the root portion 514 that is integrally provided with the ink storage bag 2. The connecting portion 610 is an approximately cylindrical member and includes an inner circumferential connecting portion 604 that is fixed and connected to the outer circumferential connecting portion 513 of the root portion 514 in a liquid-tight manner and a fan-shaped through-hole 611.

Furthermore, the nozzle 600 has a joint portion 607 as a fourth part that is connected between the longitudinal portion 631 and the connecting portion 610. The joint portion 607 is rotatably connected to both the longitudinal portion 631 and the connecting portion 610 while maintaining the sealing property of ink. The joint portion 607 is an approximately cylindrical member and has a fourth flow path 624 (fourth discharge path) extending in the longitudinal direction L. A fan-shaped through-hole 603 is formed at both ends in the longitudinal direction L of the fourth flow path 624 so as to narrow a flow path area of ink feeding in a localized manner. A surface of the joint portion 607 on which an upstream-side through-hole 603 in the ink feeding direction opens is configured to come into contact with a surface of the connecting portion 610 on which the through-hole 611 opens. A surface of the joint portion 607 on which a downstream-side through-hole 603 in the ink feeding direction opens is configured to come into contact with a surface of the longitudinal portion 631 on which the through-hole 606 opens.

The nozzle 600 includes a through-flow path 602 capable of feeding ink from the inside to the outside of the ink storage bag 2 which includes the first flow path 621 of the longitudinal portion 631, the second flow path 622 of the tip portion 632, the third flow path 512 of the root portion 514, and the fourth flow path 624 of the joint portion 607.

The joint portion 607 is relatively rotatable with respect to both the longitudinal portion 631 and the connecting portion 610 around a rotational axis that is parallel to the longitudinal direction L. The through-hole 606 of the longitudinal portion 631 and the through-hole 611 of the connecting portion 610 are configured at positions that do not intersect with a rotational axis of the joint portion 607 and are arranged and shaped so as to overlap with each other when viewed in the direction of the rotational axis. The through-holes 603 at both longitudinal ends of the joint portion 607 are also configured at positions that do not intersect with a rotational axis of the joint portion 607 and are arranged and shaped so as to overlap with each other when viewed in the direction of the rotational axis. Therefore, the through-hole 603 of the joint portion 607, and the through-hole 606 of the longitudinal portion 631 and the through-hole 611 of the connecting portion 610, are configured so that their relative positions to each other can be changed by a relative rotation of the joint portion 607, and the longitudinal portion 631 and the connecting portion 610. A rotation phase of the relative rotation includes an opened phase (open position) where the through-holes 603 at both longitudinal ends, the through-hole 606, and the through-hole 611 overlap with each other and the first flow path 621, the fourth flow path 624, and the third flow path 512 are sequentially communicated. In addition, the rotation phase of the relative rotation includes a closed phase (closed position) where the through-holes 603 at both longitudinal ends do not overlap with both the through-hole 606 and the through-hole 611 and the first flow path 621 and the third flow path 512 are not communicated with each other.

FIG. 9B shows an arrangement of the through-hole 606 and the through-hole 611 when viewed in the longitudinal direction L and FIG. 9C shows an arrangement of the through-hole 603 when viewed in the longitudinal direction L when the relative positions of the joint portion 607, the longitudinal portion 631, and the connecting portion 610 are in the opened phase. When the through-holes 603 at both longitudinal ends, and the through-hole 606 and the through-hole 611, are in the opened phase in which the through-holes overlap with each other, for example, by applying pressure to the ink storage bag 2, the ink inside the ink storage bag 2 can be discharged from the discharge port 642 (the ink can be fed) via the through-flow path 602. Accordingly, the ink can be fed to the ink supply receptacle 104 and the like.

FIG. 9D shows an arrangement of the through-hole 606 and the through-hole 611 when viewed in the longitudinal direction L and FIG. 9E shows an arrangement of the through-hole 603 when viewed in the longitudinal direction L when the relative positions of the joint portion 607, the longitudinal portion 631, and the connecting portion 610 are in the closed phase. In this state, since the through-flow path 602 is blocked between the first flow path 621 and the third flow path 512, ink is not fed downstream in the through-flow path 602 even when pressure is applied to the ink storage bag 2.

When the ink refill bottle 105 is refilled with the ink in the ink storage pouch 1e, the tip nozzle 601 of the nozzle 600 is connected to the ink supply receptacle 104 of the ink refill bottle 105 in a state where the ink supply path (through-flow path 602) is closed. Subsequently, by rotating the joint portion 607 and opening the ink supply path, the ink refill bottle 105 can be refilled with ink without any ink leakage while holding the ink storage pouch 1e with a hand in a stable manner.

Configurations of the embodiment and the respective modifications described above can be combined with each other.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-079561, filed on May 15, 2024, which is hereby incorporated by reference herein in its entirety.

What is claimed is:

1. An ink storage pouch for refilling a liquid discharge apparatus with ink, comprising:
a pouch portion for storing ink; and
a nozzle which is provided in the pouch portion and which is equipped with a discharge path that discharges ink from inside of the pouch portion,
wherein the nozzle includes a first part in which the discharge path extends in a first direction and a second part in which the discharge path extends in a second direction that intersects with the first direction.

2. The ink storage pouch according to claim 1,
wherein the nozzle includes, at a tip of the second part, a discharge port where ink is discharged to the outside of the pouch portion,
wherein the second direction is a direction that intersects with a longitudinal direction of the pouch portion.

3. The ink storage pouch according to claim 2,
wherein the first direction is the longitudinal direction of the pouch portion.

4. The ink storage pouch according to claim 2,
wherein the nozzle includes:
a port which opens to inside of the pouch portion and which introduces ink inside the pouch portion to the discharge path;
a sealing member which is arranged inside the discharge path and which is configured to be capable of switching between a sealing position where the sealing member comes into contact with a wall surface of the discharge path so as to seal the port from inside of the discharge path and a non-sealing position where the sealing member separates from the wall surface; and
a biasing member which imparts a biasing force that causes the sealing member to be positioned at the sealing position to the sealing member.

5. The ink storage pouch according to claim 4,
wherein the biasing force is set greater than a pressurizing force in a case where only the weight of ink stored inside the pouch portion acts on the biasing member.

6. The ink storage pouch according to claim 4,
wherein the port, the sealing member, and the biasing member are provided in the first part.

7. The ink storage pouch according to claim 1,
wherein the nozzle is arranged so that the first part and the second part form an approximate L-shape.

8. The ink storage pouch according to claim 2,
wherein the second part is configured so that a relative position with respect to the pouch portion is changeable,
wherein the second part is configured so that the inside of the pouch portion becomes communicable with the outside of the pouch portion via the discharge port at the relative position where a direction in which the second part extends becomes the second direction.

9. The ink storage pouch according to claim 2,
wherein the discharge path includes a first discharge path provided in the first part and a second discharge path provided in the second part,
wherein the nozzle is equipped with a flexible tube that is coupled between the first part and the second part and forms a third discharge path to connect the first discharge path and the second discharge path to each other,
wherein the first part includes a first pressing portion capable of coming into contact with an outer surface of the tube,
wherein the second part includes a second pressing portion capable of coming into contact with the outer surface at a position on an opposite side to the first pressing portion,
wherein the first part and the second part are configured to be capable of changing relative positions to each other and are capable of switching between a closed position where the first pressing portion and the second pressing portion sandwich the tube and close the third discharge path and an open position where the first pressing portion and the second pressing portion separate from each other and open the third discharge path.

10. The ink storage pouch according to claim 9,
wherein in a case where the relative position assumes the open position, a direction in which the second part extends is the second direction.

11. The ink storage pouch according to claim 9,
wherein in a case where the relative position assumes the closed position, a direction in which the second part extends is the first direction.

12. The ink storage pouch according to claim 2,
wherein the nozzle is equipped with a third part including a port which opens to inside of the pouch portion and which introduces ink inside the pouch portion to the discharge path,
wherein the first part is coupled so that a relative position with respect to the third part is changeable,
wherein the discharge path includes a first discharge path provided in the first part and a third discharge path provided in the third part,
wherein the first part is capable of switching, as the relative position with respect to the third part, between an open position where the first discharge path is communicated with the third discharge path and a closed position where the first discharge path is not communicated with the third discharge path.

13. The ink storage pouch according to claim 12,
wherein the second part is integrally constructed with the first part, and
wherein in a case where the relative position assumes the open position, a direction in which the second part extends is the second direction.

14. The ink storage pouch according to claim 2,
wherein the nozzle includes:
a third part including a port which opens to inside of the pouch portion and which introduces ink inside the pouch portion to the discharge path; and
a fourth part which couples between the first part and the third part and which is configured so that a relative position is changeable with respect to the first part and the third part,
wherein the discharge path includes a first discharge path provided in the first part, a third discharge path provided in the third part, and a fourth discharge path provided in the fourth part,
wherein the fourth part is capable of switching, as the relative position with respect to the first part and the third part, between an open position where the fourth discharge path is communicated with the first discharge path and the third discharge path and a closed position where the fourth discharge path is not communicated with the first discharge path and the third discharge path.

15. The ink storage pouch according to claim 1,
wherein the first part and the second part are coupled to each other by a bellows portion capable of changing a relative position of the first part and the second part.

16. The ink storage pouch according to claim 1,
wherein the second direction forms an angle ranging from 0° or more to 15° or less with respect to a virtual axis that passes through a center of a receptacle provided at a refill destination of ink by the ink storage pouch in a state where the pouch portion is held so that a longitudinal direction of the pouch portion is parallel to a horizontal direction.

17. The ink storage pouch according to claim 1,
wherein an angle formed between the first direction and the second direction ranges from 90° or more to 150° or less.

18. The ink storage pouch according to claim 1,
wherein the pouch portion has flexibility,
wherein the nozzle has rigidity that enables the nozzle to keep a constant shape with respect to pressure that is applied by ink stored inside the pouch portion.

19. The ink storage pouch according to claim 1,
wherein the nozzle is provided at one end in the longitudinal direction of the pouch portion.

20. The ink storage pouch according to claim 1,
wherein the nozzle is rotated to switch between an open state in which the inside of the pouch portion can communicate with the outside of the pouch portion via the discharge port and a closed state in which the inside of the pouch portion does not communicate with the outside of the pouch portion via the discharge port.
